(19) United States
(12) Patent Application Publication
(10) Pub. No.: US 2025/0061899 A1
(43) Pub. Date: Feb. 20, 2025

(54) INFORMATION CREATION METHOD, INFORMATION CREATION DEVICE, AND VIDEO FILE

(71) Applicant: FUJIFILM Corporation, Tokyo (JP)

(72) Inventors: Yuya NISHIO, Saitama (JP); Toshiki KOBAYASHI, Saitama (JP); Masaru KOBAYASHI, Saitama (JP); Kei YAMAJI, Saitama (JP)

(73) Assignee: FUJIFILM Corporation, Tokyo (JP)

(21) Appl. No.: 18/938,413

(22) Filed: Nov. 6, 2024

Related U.S. Application Data
(63) Continuation of application No. PCT/JP2023/019915, filed on May 29, 2023.

(30) Foreign Application Priority Data
Jun. 8, 2022 (JP) 2022-092861

(51) Int. Cl. G10L 15/26; G06F 16/783; G10L 15/01

(52) U.S. Cl. CPC G10L 15/26; G06F 16/7834; G06F 16/7844; G10L 15/01

(57) ABSTRACT

Provided are an information creation method and an information creation device for creating accessory information useful for learning related to a sound included in sound data, and a video file including the accessory information.

An information creation method according to one embodiment of the present invention includes a first acquisition step of acquiring sound data including a plurality of sounds emitted from a plurality of sound sources, and a creation step of creating text information obtained by converting a sound into text and related information on the conversion of the sound into text, as accessory information on video data corresponding to the sound data.

### CROSS-REFERENCE TO RELATED APPLICATIONS

This application is a Continuation of PCT International Application No. PCT/JP2023/019915 filed on May 29, 2023, which claims priority under 35 U.S.C. § 119 (a) to Japanese Patent Application No. 2022-092861 filed on Jun. 8, 2022. The above applications are hereby expressly incorporated by reference, in their entirety, into the present application.

### BACKGROUND OF THE INVENTION

### 1. Field of the Invention

One embodiment of the present invention relates to an information creation method and an information creation device for creating accessory information on video data corresponding to sound data based on the sound data. In addition, one embodiment of the present invention relates to a video file including the accessory information.

### 2. Description of the Related Art

In a case in which a video file including sound data including a sound emitted from a sound source is used, text information obtained by converting the sound included in the sound data into text may be created as accessory information on video data corresponding to the sound data (see, for example, JP2007-104405A).

### SUMMARY OF THE INVENTION

The text information obtained by converting the sound into text as described above and the video file including the text information are used, for example, for machine learning. In this case, the accuracy of the learning may be affected by the accessory information included in the video file. Therefore, there is a demand for providing the video file having the accessory information useful for the learning.

One embodiment of the present invention is to solve the above-described problem in the related art, and is to provide an information creation method and an information creation device for creating the accessory information on the sound included in the sound data, which is useful for learning.

In addition, one embodiment of the present invention is to provide a video file comprising the accessory information described above.

In order to achieve the above-described object, an aspect of the present invention relates to an information creation method comprising: a first acquisition step of acquiring sound data including a plurality of sounds emitted from a plurality of sound sources; and a creation step of creating text information obtained by converting a sound into text and related information on the conversion of the sound into text, as accessory information on video data corresponding to the sound data.

In addition, the related information may include reliability information on reliability of the conversion of the sound into text.

In addition, the information creation method according to the aspect of the present invention may further comprise a second acquisition step of acquiring video data including a plurality of image frames. In this case, in the creation step, correspondence information indicating a correspondence relationship between two or more image frames among the plurality of image frames and the text information may be created as the accessory information. In addition, the text information may be information on a phrase, a clause, or a sentence obtained by converting the sound into text, and the reliability information may be information on the reliability of the phrase, the clause, or the sentence for the sound.

In addition, the information creation method according to the aspect of the present invention may further include the second acquisition step of acquiring the video data including the plurality of image frames. In this case, in the creation step, sound source information on the sound source and presence/absence information on whether or not the sound source is present within an angle of view of a corresponding image frame may be created as the accessory information.

In addition, in a case in which the reliability of the text information is lower than a predetermined criterion, in the creation step, alternative text information on text different from the text information may be created for the sound.

In addition, the related information may include error information on an utterance error of an utterer as the sound source.

In addition, in the creation step, the reliability information may be created based on a classification of a content of the sound.

In addition, in the creation step, sound source information on an utterer as the sound source may be created. In this case, the related information may include rate information on a rate of match between movement of a mouth of the utterer and the text information.

In addition, the related information may include utterance method information on an utterance method of the sound.

In addition, in the creation step, first text information obtained by converting the sound into text by maintaining a language system of the sound and second text information obtained by converting the sound into text by changing the language system may be created as the text information. In this case, the related information may include language system information on the language system of the first text information or the second text information or change information on the change of the language system of the second text information.

In addition, the related information may include information on reliability of the second text information.

In addition, in the creation step, the text information and the reliability information may be created for each of the plurality of sounds. In this case, the information creation method may further comprise a display step of displaying statistical data obtained by executing statistical processing on the reliability information created for each of the plurality of sounds.

In addition, the information creation method may further comprise: an analysis step of analyzing, in a case in which the reliability indicated by the reliability information is lower than a predetermined criterion, a cause of the reliability being lower than the predetermined criterion; and a notification step of notifying of the cause.

In addition, in a case in which information other than the text information in the accessory information is used as non-text information, in the analysis step, the cause may be specified based on the non-text information.

In addition, the information creation method may further comprise: a determination step of determining whether or not the sound data or the video data is altered, based on the text information and movement of a mouth of an utterer of the sound in the video data.

In addition, the sound may be a verbal sound.

Another aspect of the present invention relates to an information creation device comprising: a processor, in which the processor acquires sound data including a plurality of sounds emitted from a plurality of sound sources, and the processor creates text information obtained by converting the sound into text and related information on the conversion of the sound into text, as accessory information on video data corresponding to the sound data.

Still another aspect of the present invention relates to a video file comprising: sound data including a plurality of sounds emitted from a plurality of sound sources; video data corresponding to the sound data; and accessory information on the video data, in which the accessory information includes text information obtained by converting the sound into text and related information on the conversion of the sound into text.

### BRIEF DESCRIPTION OF THE DRAWINGS

FIG. 1 is an explanatory diagram of a video file.

FIG. 2 is a diagram related to video data and sound data.

FIG. 3 is a diagram showing a configuration example of an information creation device according to one embodiment of the present invention.

FIG. 4 is a diagram related to accessory information of a sound.

FIG. 5 is a diagram related to related information in a case in which second text information is created.

FIG. 6 is a diagram related to sound source information.

FIG. 7 is a diagram related to a procedure of specifying a position of a sound source.

FIG. 8 is a diagram related to another example of the procedure of specifying the position of the sound source.

FIG. 9 is a diagram showing various types of information included in accessory information on the sound.

FIG. 10 is a diagram related to mouth shape information and rate information included in the related information.

FIG. 11 is a diagram related to utterance method information included in the related information.

FIG. 12 is a diagram related to genre information included in the related information.

FIG. 13 is a diagram related to error information included in the related information.

FIG. 14 is a diagram related to a function of an information creation device according to one embodiment of the present invention.

FIG. 15 is a diagram related to statistical data obtained by executing statistical processing on the accessory information on the sound.

FIG. 16 is a diagram related to a main flow of an information creation flow according to one embodiment of the present invention.

FIG. 17 is a diagram showing a flow of a creation step.

FIG. 18 is a diagram related to a sub-flow of the information creation flow according to one embodiment of the present invention.

FIG. 19 is a diagram showing an utterer list.

### DESCRIPTION OF THE PREFERRED EMBODIMENTS

Specific embodiments of the present invention will be described. The following embodiments are merely examples for facilitating understanding of the present invention and do not limit the present invention. The present invention may be modified or improved from the following embodiments without departing from the gist of the present invention. Further, the present invention includes its equivalents.

In the present specification, the concept of “device/apparatus” includes a single device/apparatus that exerts a specific function and includes a combination of a plurality of devices/apparatuses that exist independently and that are distributed but operate together (cooperate) to perform a specific function.

In the present specification, the term “person” means a subject that performs a specific action, and the concept of the “person” includes an individual, a group such as family, a corporation such as a company, and an organization.

In the present specification, the term “artificial intelligence (AI)” is a technology that realizes an intelligent function such as inference, prediction, and determination by using hardware resources and software resources. It should be noted that an algorithm of the artificial intelligence is optional, and examples thereof include an expert system, a case-based reasoning (CBR), a Bayesian network, and an inclusion architecture.

### One Embodiment of Present Invention

One embodiment of the present invention relates to an information creation method and an information creation device that create accessory information on video data included in a video file based on sound data included in the video file. In addition, one embodiment of the present invention relates to the video file including the accessory information.

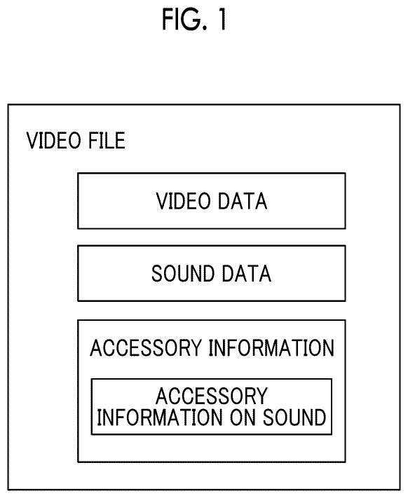

As shown in FIG. 1, the video file includes the video data, the sound data, and the accessory information. Examples of a file format of the video file include Moving Picture Experts Group (MPEG)-4, H.264, Motion JPEG (MJPEG), High Efficiency Image File Format (HEIF), Audio Video Interleave (AVI), QuickTime file format (MOV), Windows Media Video (WMV), and Flash Video (FLV).

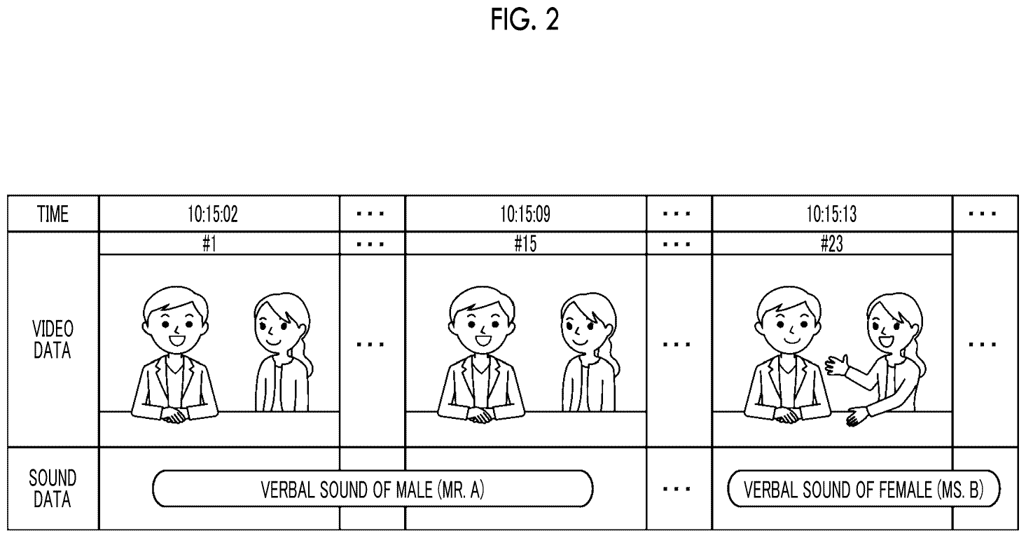

The video data is acquired by a known imaging apparatus such as a video camera and a digital camera. The imaging apparatus acquires the video data including a plurality of image frames as shown in FIG. 2 by imaging a subject within an angle of view to create the image frames at a certain frame rate. It should be noted that, as shown in FIG. 2, a frame number (denoted by #n in the drawing; n is a natural number) is assigned to each image frame in the video data.

In one embodiment of the present invention, a situation in which a plurality of sound sources emit sounds is imaged to create the video data. Specifically, at least one sound source is recorded in each image frame included in the video data, and the plurality of sound sources are recorded in the entire video data. Examples of the plurality of sound sources include a plurality of persons who have conversation or meeting, and one or more persons who utter a voice and one or more objects.

The sound data is data in which the sound is recorded, which corresponds to the video data. Specifically, the sound data includes the sounds from the plurality of sound sources recorded in the video data, and is acquired by picking up the sound emitted from each sound source during the acquisition of the video data (that is, during the imaging) via a microphone built in or externally attached to the imaging apparatus. In one embodiment of the present invention, the sound included in the sound data is mainly a verbal sound (voice), and is, for example, a human voice, a conversation sound, and the like. However, the present invention is not limited to this, and the sound may include, for example, a voice other than the human verbal sound, such as a barking voice of an animal, a laugh, and a breathing sound, and a sound that can be expressed as an onomatopoeic word (words expressed by imitating a voice). In addition, the sound included in the sound data may include a noise sound, an environmental sound, or the like in addition to a main sound such as the verbal sound.

In addition, the verbal sound may include a voice in a case of singing and a voice in a case of delivering a speech or speaking a line. It should be noted that, in the following description, a person as the sound source that emits the verbal sound is also referred to as an “utterer”.

In one embodiment of the present invention, the video data and the sound data are synchronized with each other, and the acquisition of the video data and the acquisition of the sound data are started at the same timing and end at the same timing. That is, in one embodiment of the present invention, the video data corresponding to the sound data is acquired during the same period as the period in which the sound data is acquired.

The accessory information is information on the video data that can be recorded in a box region provided in the video file. The accessory information includes, for example, tag information in an exchangeable image file format (Exif) format, specifically, tag information on an imaging date and time, an imaging location, an imaging condition, and the like.

In addition, the accessory information according to one embodiment of the present invention includes information on a subject recorded in the video data and accessory information on a sound included in the sound data.

The accessory information will be described in detail in later.

### <<Configuration Example of Information Creation Device According to One Embodiment of Present Invention>>

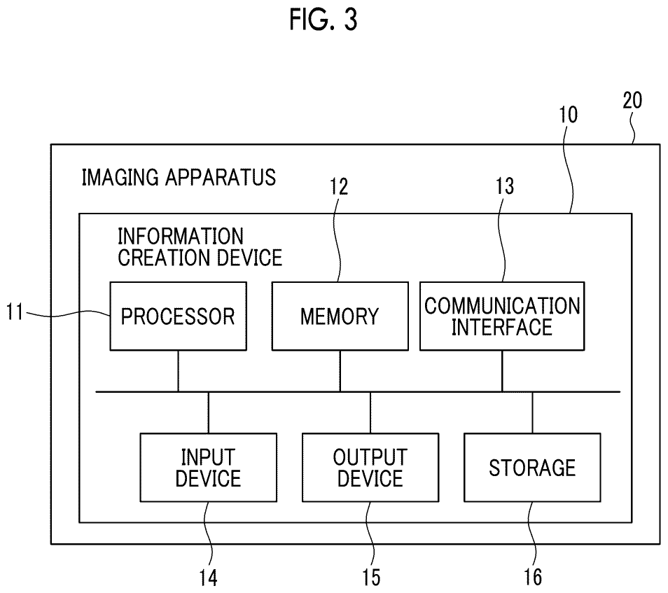

As shown in FIG. 3, the information creation device according to one embodiment of the present invention (hereinafter, an information creation device 10) comprises a processor 11, a memory 12, and a communication interface 13.

The processor 11 is configured by, for example, a central processing unit (CPU), a graphics processing unit (GPU), a digital signal processor (DSP), or a tensor processing unit (TPU).

The memory 12 is configured by, for example, semiconductor memories such as a read-only memory (ROM) and a random-access memory (RAM). The memory 12 stores a program for creating accessory information on the video data (hereinafter, an information creation program). The information creation program is a program for causing the processor 11 to execute the respective steps in the information creation method described later.

It should be noted that the information creation program may be acquired by being read from a computer-readable recording medium, or may be acquired by being downloaded via a communication network such as the Internet or an intranet.

The communication interface 13 is configured by, for example, a network interface card or a communication interface board. The information creation device 10 can communicate with another device via the communication interface 13 and can perform data transmission and reception with the device.

As shown in FIG. 3, the information creation device 10 further comprises an input device 14 and an output device 15. The input device 14 includes a device that receives a user operation, such as a touch panel and a cursor button, and a device that receives input of the voice, such as a microphone. The output device 15 includes a display device such as a display and an acoustic device such as a speaker.

The information creation device 10 can freely access various types of data stored in a storage 16. The data stored in the storage 16 includes data required for creating the accessory information. Specifically, data for specifying the sound source of the sound included in the sound data, data for identifying the subject recorded in the video data, and the like are stored in the storage 16.

It should be noted that the storage 16 may be built in or externally attached to the information creation device 10, or may be configured by a network-attached storage (NAS) or the like. Alternatively, the storage 16 may be an external device communicable with the information creation device 10 via the Internet or a mobile communication network, that is, for example, an online storage.

In one embodiment of the present invention, as shown in FIG. 3, the information creation device 10 is mounted in the imaging apparatus such as the video camera. A mechanical configuration of the imaging apparatus (hereinafter, referred to as an imaging apparatus 20) comprising the information creation device 10 is substantially the same as that of a known imaging apparatus capable of acquiring the video data and the sound data. In addition, the imaging apparatus 20 comprises an internal clock and has a function of recording a time at each point in time during the imaging. As a result, it is possible to specify the imaging time of each image frame of the video data.

The imaging apparatus 20 images the subject within the angle of view via an imaging lens (not shown), creates the image frame in which the subject is recorded at a certain frame rate, and acquires the video data. In addition, the imaging apparatus 20 acquires the sound data by picking up the sound emitted from the sound source (specifically, the verbal sound of the utterer) in the periphery of the apparatus via the microphone or the like during the imaging. Further, the imaging apparatus 20 creates the accessory information based on the acquired video data and the acquired sound data, and creates the video file including the video data, the sound data, and the accessory information.

The imaging apparatus 20 may have an autofocus (AF) function of automatically focusing on a predetermined position within the angle of view and a function of specifying a focal position (AF point) during the imaging. The AF point is specified as a coordinate position in a case in which a reference position within the angle of view is set as an origin. The angle of view is a range in data processing in which the image is displayed or drawn, and the range is defined as a two-dimensional coordinate space with two axes orthogonal to each other as coordinate axes.

The imaging apparatus 20 may further comprise a finder into which the user (that is, a person who captures an image) looks during the imaging. In this case, the imaging apparatus 20 may have a function of detecting a position of a gaze of the user and a position of a pupil of the user during the use of the finder, to specify a gaze position of the user. The gaze position of the user corresponds to a position of an intersection between the gaze of the user looking into the finder and a display screen (not shown) in the finder.

The imaging apparatus 20 may be provided with a known distance sensor such as an infrared sensor, and, in this case, a distance (depth) of the subject within the angle of view in a depth direction can be measured by the distance sensor.

### <<Accessory Information>>

In one embodiment of the present invention, the accessory information on the video data is created by the functions of the information creation device 10 mounted in the imaging apparatus 20. The created accessory information is attached to the video data and the sound data to be a constituent element of the video file.

The accessory information is, for example, created during a period in which the imaging apparatus 20 acquires the video data and the sound data (that is, during the imaging). However, the present invention is not limited to this, and the accessory information may be created after the end of the imaging.

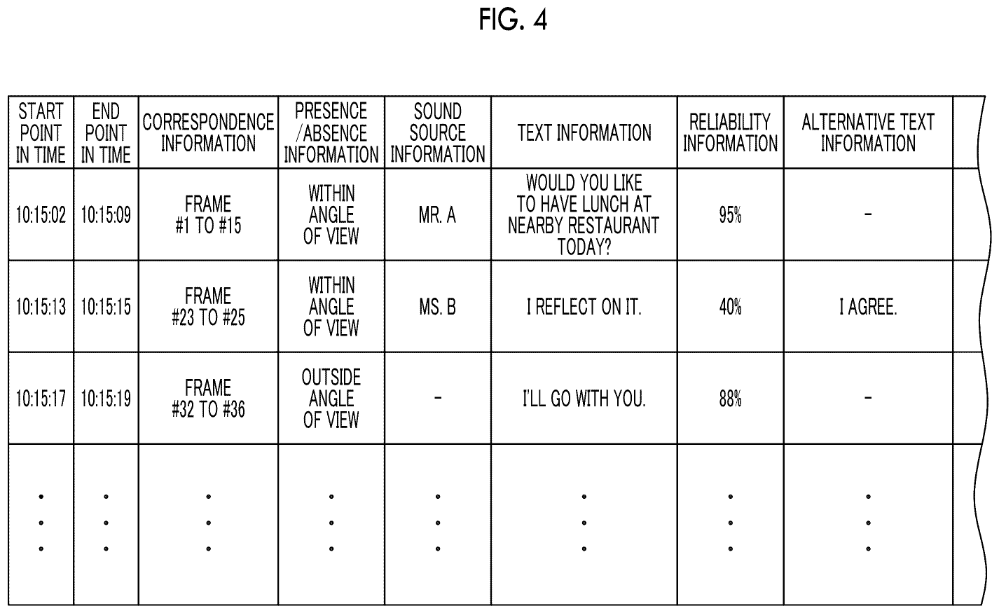

In one embodiment of the present invention, the accessory information includes information (hereinafter, accessory information on the sound) created based on the sound data. The accessory information on the sound is information on the sound emitted from the sound source stored in the video data, and is specifically information on the sound (verbal sound) uttered by the utterer as the sound source. The accessory information on the sound is created each time the utterer utters the verbal sound. In other words, as shown in FIG. 4, the accessory information on the sound is created for each sound for each of the plurality of sounds from the plurality of sound sources included in the sound data.

As shown in FIG. 4, the accessory information on the sound includes text information obtained by converting the sound into text and correspondence information.

The conversion into text is to execute natural language processing on the sound, and specifically means to recognize the sound such as the verbal sound, analyze the meaning of the speech (word) represented by the verbal sound, and assign a plausible word from the meaning. In addition, the text information is information created by the conversion into text. More specifically, since the sound including a plurality of words, such as a conversation sound, represents a phrase, a clause, or a sentence, the text information is information on the phrase, the clause, or the sentence obtained by converting the sound into text. That is, the text information is a document of an utterance content of the utterer, and the meaning (utterance content) of the verbal sound uttered by the utterer can be easily specified by referring to the text information.

It should be noted that the “phrase” is, for example, a collection of two or more words of a noun and an adjective, and functions as one part of speech. The “clause” is a collection of two or more words, functions as one part of speech, and includes at least a subject and a verb. The “sentence” is composed of one or more clauses, and the sentence is completed by a period.

The text information is created by a function of the information creation device 10 provided in the imaging apparatus 20. The function of the conversion into text is realized by, for example, artificial intelligence (AI), specifically, a learning model that estimates the phrase, the clause, or the sentence from the input sound and outputs text information.

In one embodiment of the present invention, first text information obtained by converting the sound into text by maintaining a language system of the sound is created as the text information. The language system of the sound is a concept representing a classification of a language (specifically, a type of the language such as Japanese, English, and Chinese) and whether the language is a standard language or a language variation (a dialect, a secret language, a slang, and the like). Maintaining the language system of the sound means to use the same language system as the language system of the sound. That is, for example, in a case in which the language system of the sound is the standard language of Japanese, the text information (first text information) is created by converting the sound into text using the standard language of Japanese.

It should be noted that the language system used in a case of creating the text information may be, in advance, automatically set on the imaging apparatus 20 side or designated by the user or the like of the imaging apparatus 20. Alternatively, artificial intelligence (AI) may be used to estimate the language system of the sound based on the characteristics of the sound or the like.

The correspondence information is information on a correspondence relationship between two or more image frames among the plurality of image frames included in the video data and the text information. Specifically, the sound (verbal sound) uttered from the utterer may be over a period of time corresponding to the plurality of frames. As shown in FIG. 4, the text information obtained by converting the sound into text in this case is associated with two or more image frames captured during the generation of the sound. In one embodiment of the present invention, the correspondence information indicating the correspondence relationship between the two or more image frames and the text information is created as the accessory information on the sound.

Specifically, as shown in FIG. 4, the correspondence information on time of each of a start point in time and an end point in time of a generation period of the sound converted into text is created. Alternatively, for each of the start point in time and the end point in time of the generation period of the sound converted into text, information on a frame number of the image frame captured at the point in time may be created as the correspondence information.

The video file including the text information and the correspondence information as the accessory information can be used, for example, as training data in machine learning for speech recognition. By this machine learning, it is possible to construct a learning model (hereinafter, a speech recognition model) that converts the verbal sound in an input video into text and outputs the converted verbal sound. The speech recognition model can be used, for example, as a tool for displaying a subtitle on a screen during video playback.

In addition, in one embodiment of the present invention, as the text information, together with the first text information obtained by converting the sound included in the sound data into text by maintaining the language system of the sound included, the second text information can be created by changing the language system. The second text information is information obtained by converting the sound into text using a language system different from the language system of the sound included in the sound data, in other words, the second text information is created by changing the language system of the sound uttered by the utterer into another language system.

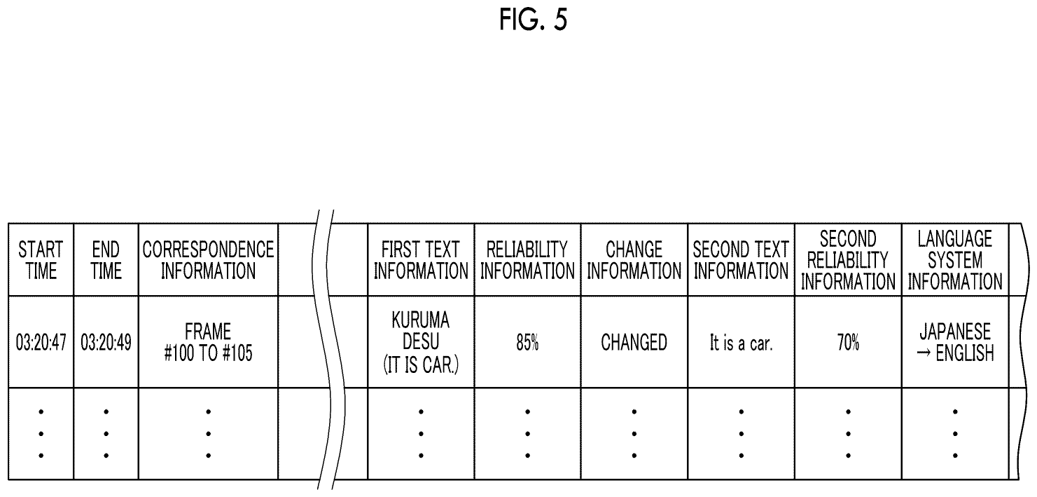

For example, in a case in which the sound included in the sound data is Japanese, the text information (first text information) is created in Japanese. In this case, as shown in FIG. 5, the second text information in which the phrase, the clause, or the sentence having the same meaning as the text information is translated into a language (for example, English) other than Japanese is created. In addition, in a case in which the text information (first text information) is created based on a dialect used in a certain region in Japan, the second text information in which the phrase, the clause, or the sentence having the same meaning as the text information is converted into the standard language of Japanese is created.

The second text information is created by using, for example, AI different from the AI used for the creation of the first text information, such as AI for translation. The language system used for the creation of the second text information may be, in advance, automatically designated on the imaging apparatus 20 side or selected by the user of the imaging apparatus 20. The second text information may be created by converting the first text information. Alternatively, the sound included in the sound data may be directly converted into text by using the changed language system, to create the second text information.

In one embodiment of the present invention, as shown in FIG. 4, the accessory information on the sound includes reliability information as related information on the conversion of the sound included in the sound data into text. The reliability information is information on reliability of the conversion of the sound into text, and is information on reliability of the text information. It should be noted that, in a case in which the first text information and the second text information are created as the text information, the reliability information is created as information on reliability of the first text information.

The reliability is the accuracy in a case in which the sound is converted into text, that is, the reliability of the phrase, the clause, or the sentence for the sound (converted into text), and is specifically an indicator indicating the certainty (likelihood) or the ambiguity of the assigned phrase and clause. The reliability is represented by, for example, a numerical value calculated by taking into consideration the clarity of the sound, the noise, and the like by AI, a numerical value derived from a calculation expression for quantifying the reliability, a rank or a division determined based on the numerical value, or an evaluation term used in a case of qualitatively evaluating the reliability (specifically, “high⋅medium⋅low” or the like).

It should be noted that, it is preferable that the reliability information is calculated in a set with the text information on the sound data by AI or the like.

The reliability information is created for each text information as shown in FIG. 4, that is, is created for each sound converted into text. The method of creating the reliability information is not particularly limited, and, for example, the reliability information may be created by using the phrase, the clause, or the sentence that is converted into text, that is, an algorithm or a learning model for calculating the certainty of the output result. In addition, the reliability information may be created based on the clarity of the sound (verbal sound), the presence or absence of the noise, and the like. Further, the reliability information may be created based on the presence or absence of homonyms or words having a similar pronunciation.

By executing machine learning using the video file including the reliability information as the accessory information as the training data, the learning accuracy, that is, the accuracy of the speech recognition model described above can be improved. That is, the learning accuracy may be affected by the reliability of the video file, which is the training data, or the reliability of the text information. By creating the reliability information on the reliability of the text information as the accessory information, the reliability of the text information can be taken into consideration in a case of executing the machine learning.

Specifically, the video file can be sorted (annotated) based on the reliability of the text information. In addition, the video file is weighted in accordance with the reliability of the text information, and, for example, the weight is set to be lower for the video file having lower reliability of the text information. As a result, it is possible to obtain a more appropriate learning result.

In addition, in one embodiment of the present invention, as shown in FIG. 4, for the text information having the reliability lower than a predetermined criterion, alternative text information may be additionally created for the sound. The alternative text information is created for a certain sound as an alternative candidate in a case in which the reliability of the text information of the sound is lower than the predetermined criterion, and is information on text different from the text information. In FIG. 4, since the reliability of the conversion into text is low for the text information “I reflect on it (hansei shimasu)”, alternative text information “I agree (sansei shimasu)” is created. As a result, even in a case in which there is a possibility that the text information is erroneous, the alternative text information as a candidate alternative for the text information can be prepared, and the alternative text information can be appropriately used as necessary.

For the video file including the text information having low reliability, it is necessary to correct the video file in a targeted manner in order to use the video file as the training data, but the video file as a correction target can be easily found by creating the alternative text information. In addition, for the text information having low reliability, the correction work is facilitated, such as replacement with the alternative text information. The corrected video file may be used as the training data for the re-learning.

It should be noted that a determination criterion (predetermined criterion) as to whether or not to create the alternative text information has an appropriate level for ensuring the reliability of the text information, and may be set in advance or may be appropriately reviewed after being set. In addition, in a case of creating the alternative text information, the number of created pieces (that is, the number of alternative candidates) is not particularly limited, and may be optionally determined.

In addition, in a case in which the first text information and the second text information are created as the text information, as shown in FIG. 5, information on reliability of the second text information (hereinafter, second reliability information) may be created as the related information. The reliability of the second text information is an indicator indicating the accuracy (conversion accuracy) in a case in which the second text information is created by changing the language system. By creating the second reliability information, it is possible to take the reliability into consideration in a case in which the second text information is used.

It should be noted that the reliability of the second text information is specified based on the consistency between the second text information and the corresponding first text information, the contents of the plurality of sounds included in the sound data (specifically, a genre described later), and the like.

In one embodiment of the present invention, as shown in FIG. 4, the accessory information on the sound further includes presence/absence information and sound source information. In a case in which these pieces of information are included in the video file as the accessory information, the usefulness of the video file is improved, and, for example, the accuracy of the machine learning using the video file as the training data can be improved.

The presence/absence information is information on whether or not the sound source of the sound included in the sound data is present within the angle of view of the corresponding image frame. Specifically, as shown in FIG. 4, the presence/absence information is information on whether or not the utterer of the sound is present within the angle of view of the image frame captured during the utterance. Whether or not the sound source is present within the angle of view may be determined based on movement of a mouth of the sound source recorded in the video data (that is, the utterer within the angle of view). Alternatively, in a case in which a sound pickup microphone is a directional microphone, whether or not the sound source is present within the angle of view may be determined based on a sound pickup direction. Specifically, the sound pickup direction of the directional microphone may be set to be directed to a space corresponding to the angle of view, and in a case in which a sound direction is deviated from the sound pickup direction, it may be determined that the sound source is present outside the angle of view. In addition, it is preferable that the directional microphone is a microphone that can combine a plurality of microphone elements to pick up sound over a wide range of 180° or more (preferably) 360° and determine a direction of each of the pickup sounds.

The sound source information is information on the sound source, particularly the utterer, is created for each sound converted into text, that is, the text information as shown in FIG. 4, and is associated with the text information. By creating the sound source information in association with the text information in this way, the utterer as the sound source and the text information of the sound can be associated with each other through the accessory information (tag).

The sound source information may be, for example, identification information of the utterer as the sound source. The identification information on the utterer is information on the utterer specified from characteristics of a region in which the utterer is present in the image frame of the video data, and is, for example, information for specifying a person, such as a name or an ID of the utterer. As the method of identifying the utterer from the video or the image, a known subject identification technology, such as a face matching technology, need only be used.

It should be noted that examples of the characteristics of the region in which the utterer is present in the image frame include hue, chroma saturation, brightness, a shape, a size, and a position of the region within the angle of view.

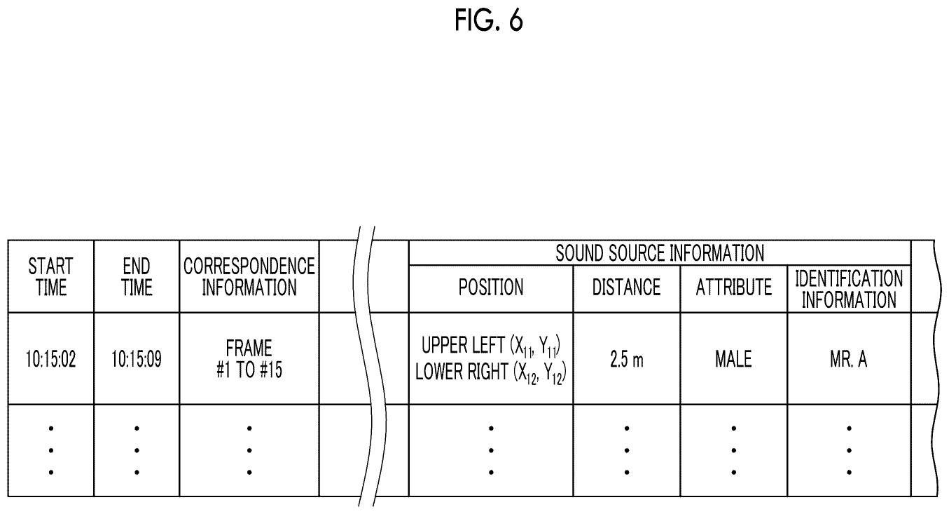

The sound source information may include information other than the identification information, for example, position information, distance information, attribute information, and the like as shown in FIG. 6.

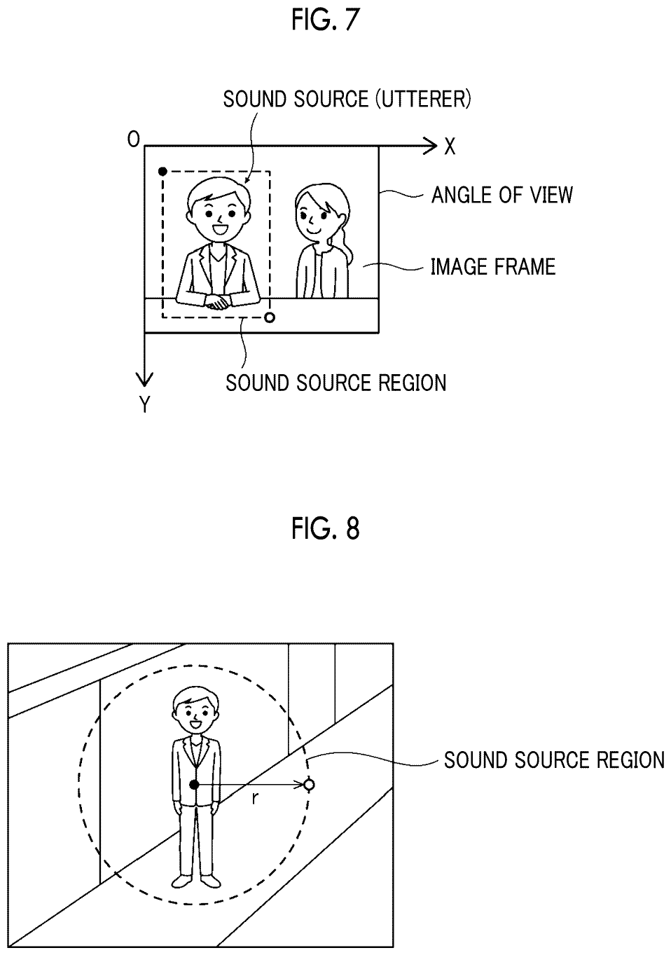

The position information is information on a position of the sound source within the angle of view, specifically, information on a coordinate position of the sound source with a reference position within the angle of view as an origin. The method of specifying the position is not particularly limited, but, for example, as shown in FIG. 7, a region (hereinafter, a sound source region) that surrounds a part or the entirety of the sound source is defined in the angle of view. In a case in which the sound source region is a rectangular region, coordinates of two intersections (points indicated by a white circle and a black circle in FIG. 7) located at both ends of a diagonal line at an edge of the region may be specified as the position (coordinate position) of the sound source. On the other hand, for example, in a case in which the sound source region is a circular region as shown in FIG. 8, the position of the sound source may be specified by the coordinates of the center (base point) of the region and a distance from the base point to the edge of the region (that is, a radius r). It should be noted that, even in a case in which the sound source region is a rectangular region, the position of the sound source may be specified by the coordinates of the center (intersection of the diagonal lines) of the region and the distance from the center to the edge.

The distance information is information on a distance (depth) of the sound source within the angle of view, and is, for example, a measurement result obtained by a distance-measuring sensor mounted in the imaging apparatus 20.

The attribute information is information on an attribute of the sound source within the angle of view, and is specifically information on an attribute of the utterer within the angle of view, such as gender and age. For the attribute of the utterer, based on the characteristics of the region (that is, the sound source region) in the image frame of the video data in which the utterer is present, for example, a known clustering method may be applied to specify division (class) to which the attribute of the utterer belongs, in accordance with a predetermined classification criterion.

It should be noted that the sound source information described above may be created only for the sound source present within the angle of view, and need not be created for the sound source present outside the angle of view. However, the present invention is not limited to this, and even for the sound source (utterer) present outside the angle of view that is not recorded in the image frame, the identification information of the utterer can be created as the sound source information by specifying a voiceprint from the sound (voice) of the utterer and using a technology such as voiceprint collation.

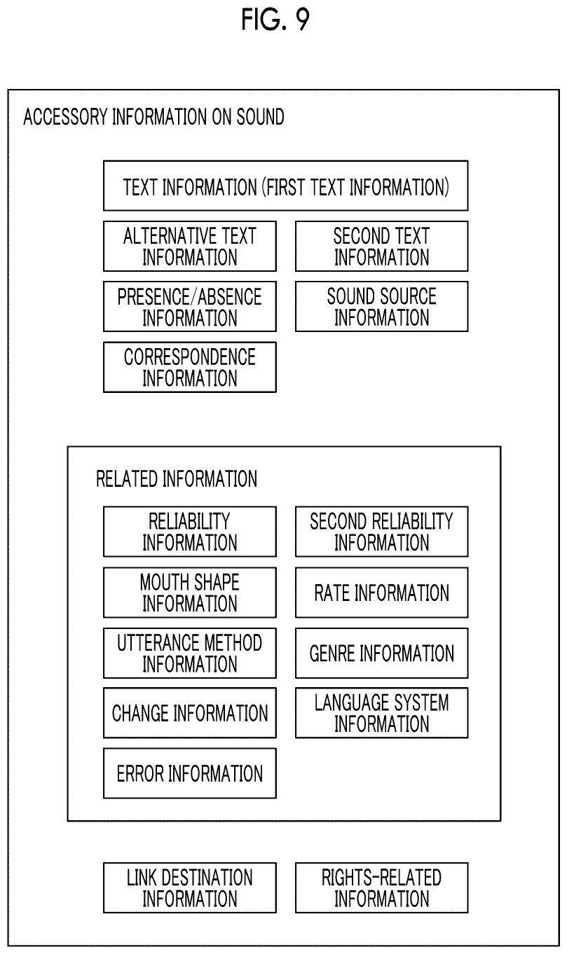

In one embodiment of the present invention, as shown in FIG. 9, the related information may include mouth shape information, rate information, utterance method information, change information, language system information, genre information, error information, and the like, in addition to the reliability information and the second reliability information.

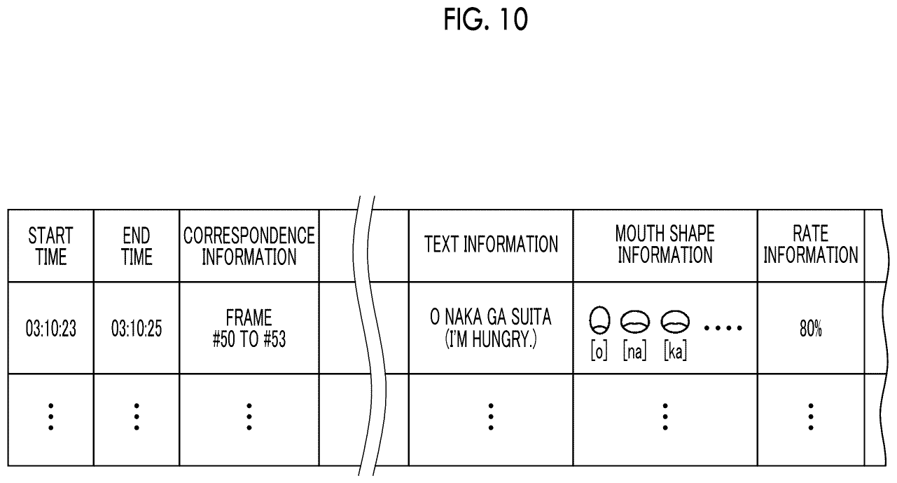

As shown in FIG. 10, the mouth shape information is created in a case in which the utterer, who is the sound source of the sound converted into text, is present within the angle of view, and is information on a change in a shape of the mouth of the utterer in a case of uttering the sound (that is, movement of the mouth). By recording the mouth shape information as the accessory information in the video file, it is possible to more effectively use the video file as the training data for the machine learning. Specifically, the video file including the mouth shape information is useful, for example, in a case in which machine learning for constructing a learning model that predicts an utterance sound from the movement of the mouth is executed.

It should be noted that the movement of the mouth can be specified from a video of the utterer recorded in the video data, specifically, a video of a mouth portion during the utterance.

As shown in FIG. 10, the rate information is information on a rate of match between the movement of the mouth of the utterer and the text information, and is created in a case in which the mouth shape information is created as the related information. The rate of match is an indicator of how much the movement of the mouth of the utterer in a case of uttering the verbal sound matches (is aligned with) the text information of the sound. Since the rate of match can be said to correspond to one reliability of the text information, the reliability of the text information can be specified from the movement of the mouth of the utterer by creating the rate information. That is, the rate information in which the reliability is specified from the viewpoint of the rate of match between the movement of the mouth of the utterer and the text information can be included in the video file. As a result, in a case in which the machine learning is executed by using the video file as the training data, the reliability of the text information can be further taken into consideration.

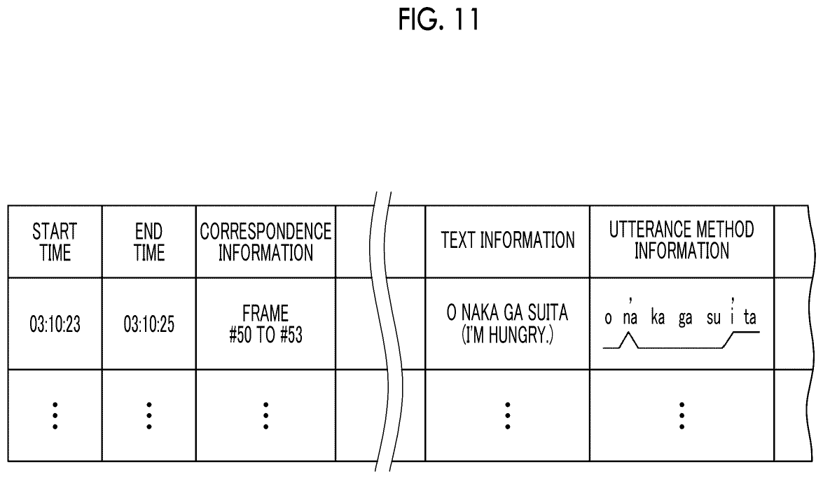

As shown in FIG. 11, the utterance method information is information on the accent or the intonation of the sound, and is specifically information on the accent or the intonation in a case of pronouncing the text information. Here, the concept of “accent” also includes the intensity of the sound in a phrase, clause, or sentence unit in addition to the intensity of the sound in each word. Further, the concept of “accent” also includes a pitch of the sound in a word, phrase, or sentence unit. In addition, the “intonation” includes intonation in a word, phrase, clause, or sentence unit.

By creating the utterance method information as the accessory information, it is possible to use the video file including the text information and the utterance method information. As a result, for example, a learning model (speech recognition model) that takes into account the relevance (correspondence relationship) between the phrase, the clause, or the sentence indicated by the text information and the utterance method can be constructed.

In a case in which the first text information and the second text information are created as the text information, the utterance method information may be created for each of the first text information and the second text information.

The change information and the language system information are both created in a case in which the first text information and the second text information are created as the text information. It should be noted that at least one of the change information or the language system information need only be created, any one of the change information or the language system information may be created, or both the change information and the language system information may be created.

As shown in FIG. 5, the change information is information on a change in the language system (specifically, a change of the second text information to the language system). By creating the change information, it is possible to recognize that the second text information is created by changing the language system, for the sound included in the sound data.

The language system information is information on a language system of the first text information or the second text information, and indicates a type of the language system before and after the change as shown in FIG. 5. The type of the language system indicates the classification such as Japanese, English, or Chinese, whether the dialect or the standard language is uttered, and which regional dialect is uttered.

Both the change information and the language system information correspond to the sound for which the second text information is created, and are associated with the second text information and the first text information as shown in FIG. 5.

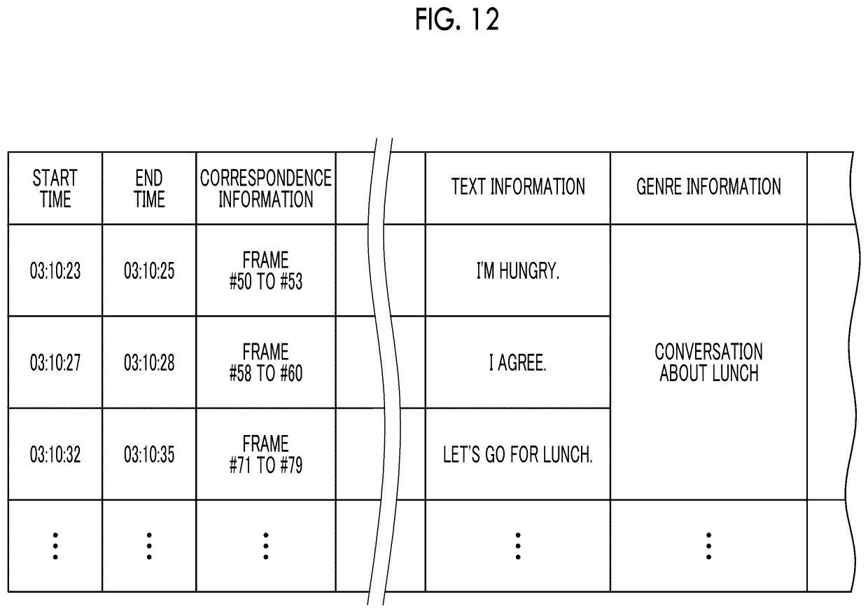

The genre information is information on a classification (hereinafter, also referred to as a genre) of the content of the sound. For example, in a case in which the sound data includes the conversation sound of a plurality of persons, the genre of the conversation sound is specified by analyzing the sound data, and the genre information for the specified genre is created as shown in FIG. 12.

The method of specifying the genre is not limited to analyzing the sound data, and the genre may be specified based on the video data. Specifically, the video during a period in which the plurality of sounds are generated (for example, during a conversation period) in the video data may be analyzed to recognize a scene or a background of the video, and the genre of the sound may be specified in consideration of the recognized scene or background. In this case, the scene or the background of the video may be recognized by a known subject detection technology, scene recognition technology, or the like.

It should be noted that the genre is specified by AI for specifying the genre, specifically, AI different from the AI used for creating the text information.

The genre information is referred to, for example, in a case in which the reliability information is created. That is, the reliability information for the conversion of a certain sound into text may be created based on the genre of the sound. Specifically, in a case in which the content of the text information matches the genre of the sound, it is preferable to create the reliability information indicating the reliability that is higher than the predetermined criterion. On the contrary, in a case in which the content of the text information is inconsistent with the genre of the sound, it is preferable to create the reliability information indicating the reliability that is lower than the predetermined criterion.

By creating the genre information, the content of the sound converted into text (specifically, the meaning of the word in the text information) can be understood in consideration of the genre of the sound. For example, in the conversation of a special genre, in a case in which a certain word is used in the meaning specific to the genre (meaning different from the original meaning of the word), the meaning of the word can be correctly recognized.

The genre information is created, and the video file includes the genre information as the accessory information, so that the video of the scene in which the sound of the genre designated by the user is recorded can be found based on the genre information. That is, the genre information can be used as a search key in a case in which the video file is searched for.

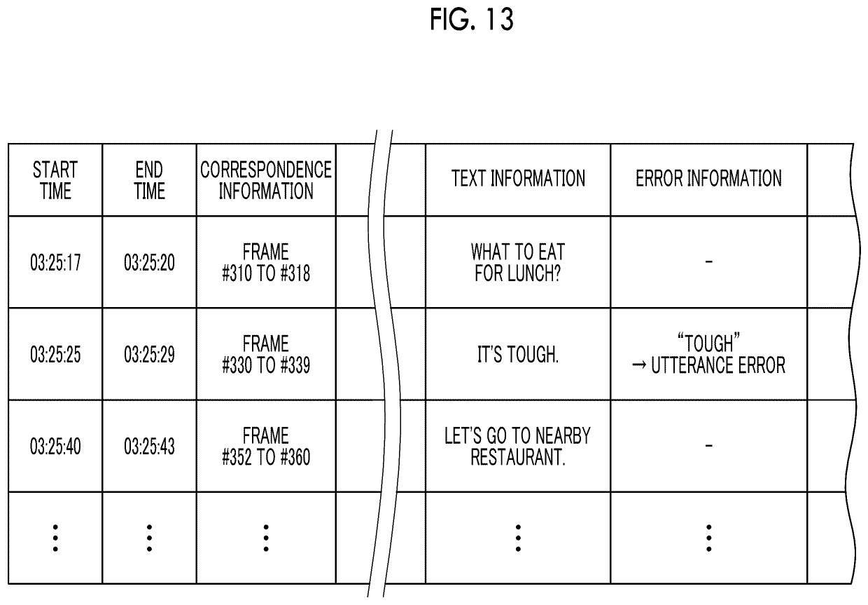

The error information is information on an utterance error of the utterer who is the sound source of the sound, and is specifically information indicating the presence or absence of the error as shown in FIG. 13. The utterance error is a slip of the tongue, a grammatical error, a misuse of a particle, a misuse of a word, or the like during the utterance of the sound (verbal sound). Whether or not there is the utterance error is determined in accordance with a predetermined criterion, and is determined, for example, based on whether or not the following matters are met.
Whether or not there is the error (for example, an unnatural word or the like) in the sound converted into text
Whether or not the usage (grammar) of the word in the sound converted into text is correct.
Whether or not the text information specified from each of the plurality of sounds included in the sound data matches (is aligned with) the context

It should be noted that whether or not there is the utterance error is specified by AI for error determination, that is, AI different from the AI used for creating the text information. In addition, for the sound having the utterance error, the verbal sound in which the error is corrected (hereinafter, referred to as a corrected sound) may be predicted, and the text information of the corrected sound may be further created.

The error information is created, and the machine learning is executed using the video file including the error information as the training data, so that the accuracy of the learning can be improved. Specifically, in a case in which the weight is set for the video file used as the training data and the machine learning is executed by reflecting the weight, the weight is lowered for a file having the utterance error in the sound included in the sound data. With such weighting, it is possible to obtain a more appropriate learning result in the machine learning.

In one embodiment of the present invention, as shown in FIG. 9, the accessory information on the sound may further include link destination information and rights-related information.

The link destination information is information indicating a link to a storage destination (save destination) of the voice file in a case in which the same sound data as the sound data of the video file is created as a separate file (voice file). It should be noted that the sound data of the video file includes the plurality of sounds emitted from the plurality of sound sources (utterers), and the voice file may be created for each sound source (for each utterer). In this case, the link destination information is created for each voice file (that is, for each utterer).

The rights-related information is information on the attribution of a right related to the sound included in the sound data and the attribution of a right related to the video data. For example, in a case in which the video file is created by imaging a scene in which a plurality of artists sing a song in order, the right (copyright) of the video data is attributed to a creator of the video file (that is, a person who captures the video). On the other hand, the right related to the sound (singing) of each of the plurality of artists recorded in the sound data is attributed to each artist or an organization to which the artist belongs, or the like. In this case, the rights-related information that defines the attribution relationship of these rights is created.

### <<Function of Information Creation Device>>

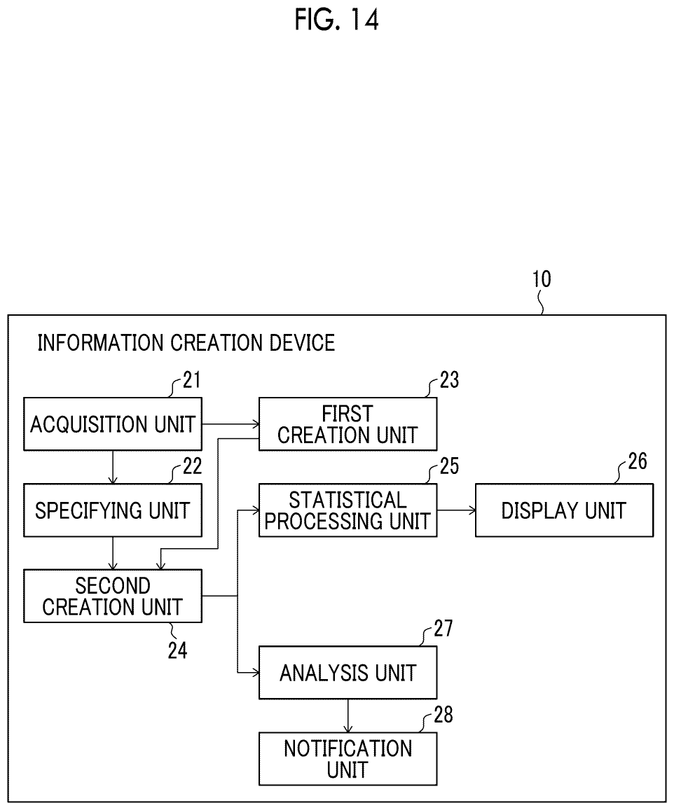

The function of the information creation device 10 according to one embodiment of the present invention will be described with reference to FIG. 14.

The information creation device 10 includes, as shown in FIG. 14, an acquisition unit 21, a specifying unit 22, a first creation unit 23, a second creation unit 24, a statistical processing unit 25, a display unit 26, an analysis unit 27, and a notification unit 28. These functional units are realized by the hardware devices (processor 11, memory 12, communication interface 13, input device 14, output device 15, and storage 16) of the information creation device 10 and the software including the above-described information creation program in cooperation with each other. Some functions are realized by using artificial intelligence (AI).

Hereinafter, the respective functional units will be described.

### (Acquisition Unit)

The acquisition unit 21 controls each unit of the imaging apparatus 20 to acquire the video data and the sound data. In one embodiment of the present invention, the acquisition unit 21 simultaneously creates the video data and the sound data while synchronizing the video data and the sound data with each other in a situation in which the plurality of sound sources emit the sounds (verbal sounds) in order. Specifically, the acquisition unit 21 acquires the video data consisting of the plurality of image frames such that at least one sound source is recorded in one image frame. In addition, the acquisition unit 21 acquires the sound data including the plurality of sounds emitted from the plurality of sound sources recorded in the plurality of image frames included in the video data. In this case, each sound corresponds to two or more image frames acquired (captured) during the generation period of the sound among the plurality of image frames.

### (Specifying Unit)

The specifying unit 22 specifies the content related to the sound included in the sound data, based on the video data and the sound data acquired by the acquisition unit 21.

Specifically, the specifying unit 22 specifies the correspondence relationship between the sound and the image frame for each of the plurality of sounds included in the sound data, and specifies two or more image frames acquired during the generation period of the sound.

Further, the specifying unit 22 specifies the sound source (utterer) for each sound.

Further, the specifying unit 22 specifies whether or not the sound source of the sound is present within the angle of view of the corresponding image frame. In a case in which the sound source is present within the angle of view, the specifying unit 22 specifies the position and the distance (depth) of the sound source present within the angle of view, and also specifies the attribute and the identification information of the sound source. Further, the specifying unit 22 specifies the movement of the mouth of the sound source (utterer) present within the angle of view during the utterance.

In addition, the specifying unit 22 specifies the genre (specifically, the classification of the content of the conversation or the like) for the plurality of sounds included in the sound data.

In addition, the specifying unit 22 specifies the utterance method, such as the accent of the sound, for each sound.

In addition, the specifying unit 22 specifies the presence or absence of the utterance error and the content of the utterance error for each sound.

### (First Creation Unit and Second Creation Unit)

The first creation unit 23 and the second creation unit 24 each create the accessory information on the sound for each of the plurality of sounds included in the sound data.

The first creation unit 23 creates the text information obtained by converting the sound into text. In one embodiment of the present invention, the first creation unit 23 creates the text information (specifically, the first text information) by converting the sound into text by maintaining the language system of the sound. In addition, the first creation unit 23 can create the second text information obtained by converting the sound into text by changing the language system.

The second creation unit 24 creates information other than the text information (hereinafter, also referred to as non-text information) of the accessory information on the sound.

Specifically, the second creation unit 24 creates the correspondence information on the correspondence relationship, based on the correspondence relationship between the sound specified by the specifying unit 22 and the image frame.

In addition, the second creation unit 24 creates the related information on the conversion of the sound into text. The related information includes the reliability information on the reliability of the conversion of the sound into text. In this case, the second creation unit 24 may create the reliability information based on the genre of the sound specified by the specifying unit 22. Specifically, the second creation unit 24 may create the reliability information based on the match between the genre of the sound and the content of the text information.

In addition, in a case in which the second text information is created as the text information, the second creation unit 24 creates the second reliability information on the reliability of the second text information as the related information. Further, the second creation unit 24 creates at least one of the change information on the change of the language system of the second text information or the language system information on the language system of the first text information or the second text information, as the related information.

In addition, the second creation unit 24 creates the utterance method information on the utterance method as the related information based on the utterance method of the sound specified by the specifying unit 22.

In addition, the second creation unit 24 creates the genre information on the genre as the related information based on the genre of the sound specified by the specifying unit 22.

In addition, the second creation unit 24 creates the mouth shape information on the movement of the mouth as the related information based on the movement of the mouth of the sound source (utterer) specified by the specifying unit 22. In this case, the second creation unit 24 may further create the rate information on the rate of match between the movement of the mouth of the utterer and the text information as the related information.

In addition, in a case in which the specifying unit 22 specifies the utterance error of the utterer, the second creation unit 24 creates the error information on the utterance error as the related information.

In addition, the second creation unit 24 creates the presence/absence information on whether or not the sound source of the sound is present within the angle of view of the corresponding image frame, as the information other than the related information. Further, the second creation unit 24 creates the sound source information on the sound source present within the angle of view, specifically, the identification information of the sound source, the position information, the distance information, the attribute information, and the like of the sound source.

In addition, for the text information (strictly, the first text information) having the reliability lower than the predetermined criterion, the second creation unit 24 creates the alternative text information on the text different from the text information as the alternative candidate.

It should be noted that the second creation unit 24 need only create at least the reliability information among pieces of the non-text information described above, and the creation may be omitted for the other non-text information.

### (Statistical Processing Unit)

The statistical processing unit 25 executes statistical processing on the accessory information on the sound created for each of the sounds emitted from the plurality of sound sources, that is, the plurality of sounds included in the sound data, to obtain statistical data. The statistical data is data indicating a statistical amount on reliability of the text information created for each sound.

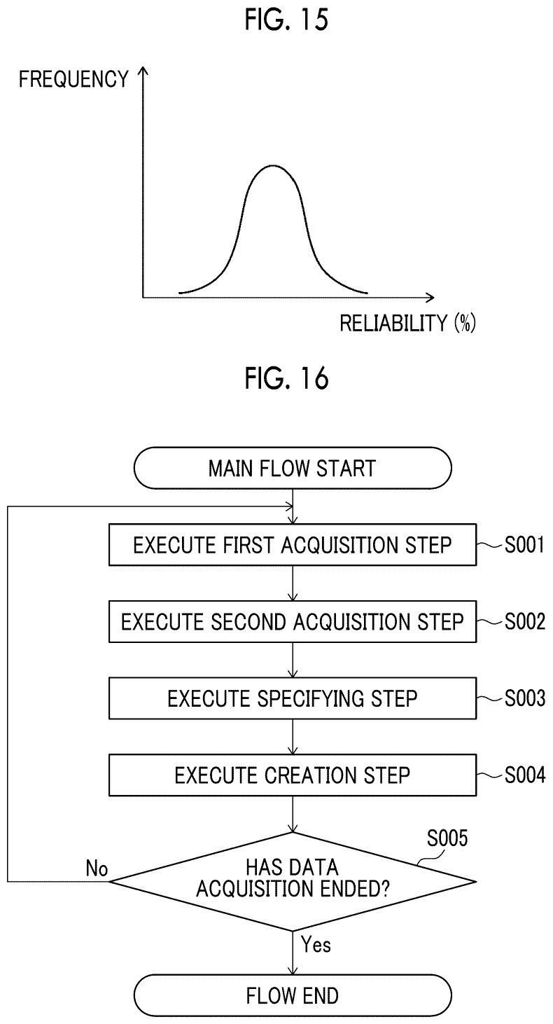

Specifically, the statistical processing unit 25 executes the statistical processing with the text information of each sound and the reliability information created for each text information, as targets. In the statistical processing, for example, a distribution of the reliability (for example, a frequency distribution) of the text information as shown in FIG. 15 is specified. As a result, it is easy to specify the image frame of the sound having low reliability in a case of being converted into text or the sound having high reliability, and it is easy to analyze the sound that is a cause.

It should be noted that, for example, in the statistical processing, all the video files created in the past may be used as the targets, and the statistical processing may be executed by collectively using, as a population, pieces of the accessory information on the sounds included in the video files. Alternatively, the statistical processing may be executed by using, as a population, the accessory information on the sound included in the video file designated by the user. In addition, in one video file, the statistical processing may be executed by using, as a population, the accessory information on the sound corresponding to the video in a period designated by the user.

### (Display Unit)

The display unit 26 displays the statistical data obtained by the statistical processing unit 25 (for example, distribution data of the reliability shown in FIG. 15). A screen on which the statistical data is displayed may be configured by a display device of the imaging apparatus 20, or may be configured by an external display as another device to which the imaging apparatus 20 is connected.

As described above, by displaying the statistical data on the reliability of the text information, the user can visually understand the accuracy of the reliability of the text information, the tendency, and the like.

### (Analysis Unit)

The analysis unit 27 analyzes the cause in a case in which the reliability indicated by the reliability information for the text information of a certain sound is lower than the predetermined criterion.

Specifically, the analysis unit 27 reads out the video file created in the past. The analysis unit 27 specifies the cause of the reliability being lower than the predetermined criterion based on the text information, the reliability information, and the non-text information other than the text information among pieces of the accessory information on the sound included in the read out video file. Here, the non-text information is, for example, the presence/absence information, the sound source information, the correspondence information, the change information, or the language system information.

More specifically, in a case in which the presence/absence information is used as the non-text information, the analysis unit 27 specifies a correlation between the presence or absence of the sound source (utterer) within the angle of view and the reliability of the text information of the sound (verbal sound) emitted from the sound source. Then, from the specified correlation, the analysis unit 27 specifies the cause of the reliability being lower than the predetermined criterion in association with the presence or absence of the sound source within the angle of view.

In addition, in a case in which the sound source information (for example, the identification information on the utterer who is the sound source) is used as the non-text information, the analysis unit 27 specifies a correlation between the identification information of the utterer and the reliability of the text information of the verbal sound of the utterer. Then, from the specific correlation, the analysis unit 27 specifies the cause of the reliability being lower than the predetermined criterion in association with the identification information on the utterer or the like. In addition, in a case in which identification information on a sound source of a sound other than the verbal sound (for example, a sound of wind or a sound of a running automobile) is obtained as the non-text information, the cause of the reliability being lower than the predetermined criterion is specified in association with the identification information of the sound source or the like.

In addition, in a case in which the correspondence information is used as the non-text information, the analysis unit 27 specifies the generation period of the sound converted into text (in other words, a length of the text), and specifies a correlation between the length of the text and the reliability of the text information. Then, from the specified correlation, the analysis unit 27 specifies the cause of the reliability being lower than the predetermined criterion in association with the length of the text.

In a case in which the change information or the language system information is used as the non-text information, the analysis unit 27 specifies the language system of the text information from the change information/language system information. For example, the analysis unit 27 specifies whether the language system of the text information is the standard language or the dialect, and in a case of the dialect, specifies which dialect of which region it is. Thereafter, the analysis unit 27 specifies a correlation between the language system of the text information and the reliability. Then, from the specified correlation, the analysis unit 27 specifies the cause in a case in which the reliability is lower than the predetermined criterion, in association with the language system of the text information.

### (Notification Unit)

The notification unit 28 notifies the user of the cause specified by the analysis unit 27 for the target sound, that is, the cause of the reliability of the text of the sound being lower than the predetermined criterion. As a result, the user can easily understand the cause of the sound having low reliability of the text information.

It should be noted that the unit for issuing cause notification is not particularly limited, and, for example, character information on the cause may be displayed on the screen, or a voice related to the cause may be output.

### <<Information Creation Flow According to One Embodiment of Present Invention>>

Hereinafter, an information creation flow using the information creation device 10 will be described. In the information creation flow to be described later, the information creation method according to the embodiment of the present invention is used. That is, each step in the information creation flow described later corresponds to a constituent element of the information creation method according to the embodiment of the present invention.

It should be noted that the following flow is merely an example, and unnecessary steps in the flow may be deleted, new steps may be added to the flow, or the execution order of two steps in the flow may be exchanged within a range not departing from the gist of the present invention.

Each step in the information creation flow is executed by the processor 11 provided in the information creation device 10. That is, in each step in the information creation flow, the processor 11 executes processing corresponding to each step in the data processing defined by the information creation program.

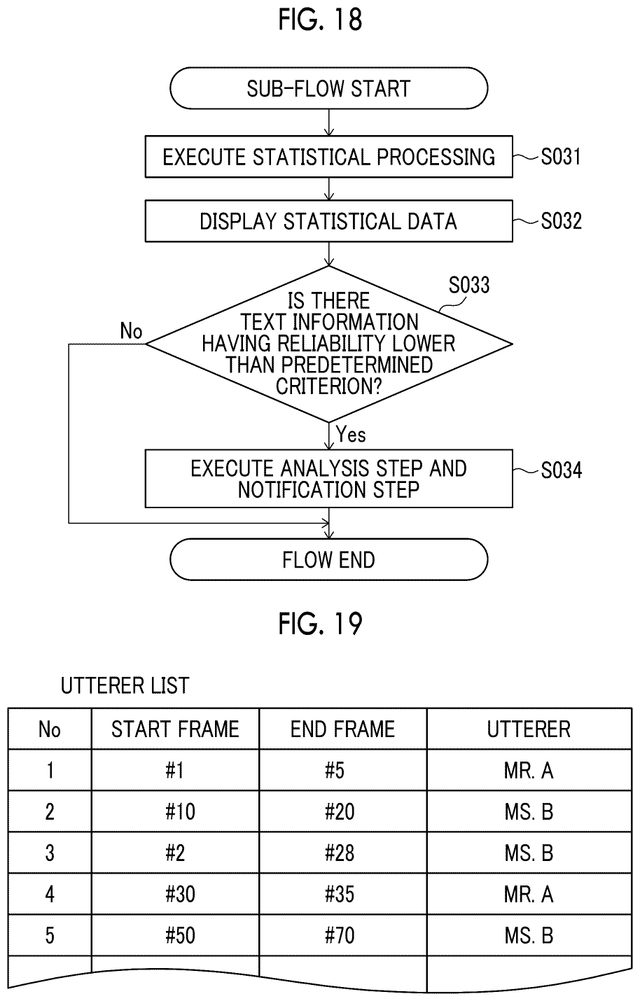

In one embodiment of the present invention, the information creation flow is divided into a main flow shown in FIG. 16 and a sub-flow shown in FIG. 18. Hereinafter, each flow will be described.

### (Main Flow)

In the main flow, the video data and the sound data are acquired, and the accessory information on the video data is created to create the video file.

In the main flow, the processor 11 executes a first acquisition step (S001) of acquiring the sound data including the plurality of sounds emitted from the plurality of sound sources and a second acquisition step (S002) of acquiring the video data including the plurality of image frames.

It should be noted that, in the flow shown in FIG. 16, the second acquisition step is executed after the first acquisition step, but, for example, in a case in which the video with sound is captured by using the imaging apparatus 20, the first acquisition step and the second acquisition step are executed at the same time.

During the execution period of the first acquisition step and the second acquisition step, the processor 11 executes a specifying step (S003) and a creation step (S004). In the specifying step, the content related to the sound included in the sound data is specified, and specifically, the correspondence relationship between the sound and the image frame, the utterance method of the sound, the presence or absence of the utterance error, the content of the utterance error, and the like are specified.

In addition, in the specifying step, it is specified whether or not the sound source of the sound is present within the angle of view of the corresponding image frame, and in a case in which the sound source is present within the angle of view, the position and the distance of the sound source within the angle of view, and the attribute and the identification information of the sound source are further specified.

In addition, in the specifying step, the movement of the mouth of the sound source (utterer) present within the angle of view during the utterance is specified.

In addition, in the specifying step, the genre of the plurality of sounds included in the sound data is specified.

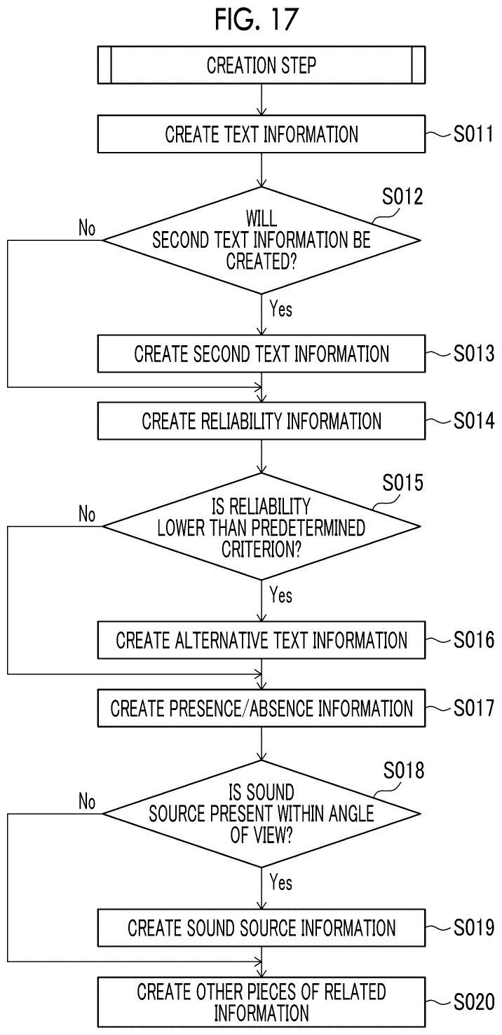

The creation step proceeds according to a flow shown in FIG. 17. In the creation step, the accessory information on the sound is created as the accessory information of the video data. Specifically, a step (S011) of creating the text information obtained by converting the sound included in the sound data into text is executed. In step S011, the sound is converted into text by maintaining the sound in the language system of the sound, to create the text information (strictly, first text information), and specifically, the text information on the phrase, the clause, or the sentence converted into text from the sound is created.

In a case in which the text information (second text information) is created by changing the language system, the second text information is created together with the first text information (S012 and S013).

It should be noted that, in a case in which the second text information is created, the change information on the change of the language system or the language system information on the language system of the first text information or the second text information may be created. In addition, the second reliability information on the reliability of the second text information may be further created.

In the creation step, a step (S014) of creating the reliability information, which is the related information, for the sound for which the text information is created is also executed. In step S014, the algorithm, the learning model, or the like for calculating the certainty for the phrase, the clause, or the sentence converted into text is used to specify the reliability of the text, and the reliability information on the reliability is created. In addition, the reliability information may be created based on the clarity of the sound (verbal sound), the presence or absence of the noise, and the like.

In addition, in a case in which the reliability information is created in the above-described manner, the reliability information may be created based on the content (specifically, the genre of the sound, the movement of the mouth of the utterer, and the like) specified in the specifying step S003.

In addition, in a case in which the text information (strictly speaking, the first text information) having the reliability lower than the predetermined criterion, as indicated by the reliability information, is present, the alternative text information on the text different from the text information is created as the alternative candidate (S015 and S016).

In the creation step, the presence/absence information on whether or not the sound source of the sound for which the text information is created is present within the angle of view of the corresponding image frame is created (S017). Further, in a case in which the sound source is present within the angle of view, the sound source information on the sound source, specifically, the position information, the distance information, the identification information, the attribute information, and the like of the sound source within the angle of view are created (S018, S019).

In the creation step, the other pieces of the related information (specifically, the correspondence information, the mouth shape information, the rate information, the genre information, the error information, the utterance method information, and the like) are also created (S020).

The specifying step and the creation step are repeatedly executed during the acquisition of the video data and the sound data (that is, during the video capturing). Then, in a case in which the acquisition of these pieces data ends (S005), the specifying step and the creation step end, and the main flow ends.

As a result of executing the series of steps in the main flow, the accessory information on the sound including the text information and the reliability information is created for each of the plurality of sounds included in the sound data. Then, the end of the main flow causes the accessory information to be added to the video data and the sound data, and the video file including the video data, the sound data, and the accessory information is created.

### (Sub-Flow)

The sub-flow is executed separately from the main flow, and is executed, for example, after the main flow ends. In the sub-flow, first, a step (S031) of executing the statistical processing on the sound data included in a target video file is executed. In step S031, the statistical processing is executed on the reliability information created for each of the plurality of sounds included in the sound data, to specify the distribution of the reliability (see FIG. 15). Thereafter, a display step is executed, and in the display step, the statistical data obtained by the statistical processing, that is, the data indicating the distribution of the reliability is displayed (S032).

In addition, in the sub-flow, in a case in which the text information having the reliability lower than the predetermined criterion is included in the text information included in the target video file, an analysis step and a notification step are executed (S033, S034). In the analysis step, the cause of the reliability of the text information being lower than the predetermined criterion is specified based on the non-text information other than the text information. More specifically, the correlation between the reliability of the text information and the content specified from the non-text information is specified, and the cause is specified (estimated) from the correlation.

In the notification step, the user is notified of the cause specified in the analysis step. As a result, the user can understand the cause of the text information having the reliability lower than the predetermined criterion.

Then, the sub-flow ends at the point in time at which the steps up to now end.

### Other Embodiments

The embodiment described above are a specific example described for easy understanding of the information creation method, the information creation device, and the video file according to the embodiment of the present invention, and is merely an example, and other embodiments can be considered.

### (File for Recording Video Data and Sound Data)

In the above-described embodiments, the video data and the sound data are acquired at the same time by capturing the video with sound via the imaging apparatus 20 provided with the microphone, and these pieces of data are included in one video file. However, the present invention is not limited to this. The video data and the sound data may be acquired by another device, and each of the data may be recorded in a separate file. In this case, it is preferable to acquire the video data and the sound data while synchronizing the video data and the sound data with each other.

### (Configuration of Information Creation Device)

In the above-described embodiments, the configuration has been described in which the information creation device according to the embodiment of the present invention is mounted in the imaging apparatus. That is, in the above-described embodiments, the accessory information on the video data is created by the imaging apparatus that acquires both the video data and the sound data. However, the present invention is not limited to this, and the accessory information may be created by an apparatus different from the imaging apparatus, specifically, a PC, a smartphone, a tablet terminal, or the like connected to the imaging apparatus. That is, a computer of a device other than the imaging apparatus may configure the information creation device, acquire the video data and the sound data from the imaging apparatus, and create the accessory information on the video data (specifically, the accessory information on the sound).

### (Utterer List)

In the above-described embodiments, the identification information of the utterer, who is the sound source, is created as the accessory information (sound source information) for each of the plurality of sounds (verbal sounds) included in the sound data. In addition to the identification information, an utterer list shown in FIG. 19 may be created. The utterer list is created by listing the utterers, who are the sound sources, in time series for each of the plurality of sounds included in the sound data and associating the utterer list with the video file including the sound data. In the utterer list, the utterer of each verbal sound is defined in association with the verbal sound and the corresponding image frame, specifically, the image frame at the start point in time of the sound generation (start frame) and the image frame at the end point in time of the sound generation (end frame).

### (Variation in Step Included in Information Creation Flow)

As described above, the information creation flow according to the embodiment of the present invention is not limited to the flow described above, and may further include a step other than the steps shown in FIGS. 16 to 18. For example, in the information creation flow, a determination step of determining whether or not the sound data or the video data in the video file is altered may be further performed.

In the determination step, whether or not the alteration (tampering) is performed is determined based on the text information and the mouth shape information corresponding to the text information among pieces of the accessory information on the sound included in the video file. Specifically, the processor 11 determines in the determination step whether or not the content of the text information matches the movement of the mouth indicated by the corresponding mouth shape information. The corresponding mouth shape information is information on the movement of the mouth of the utterer of the sound, which is specified from the video in the generation period of the sound converted into text (verbal sound) in the video data. In a case in which the content of the text information and the movement of the mouth do not match, the processor 11 determines “altered”.

By executing the determination step, in a case in which the sound data or the video data is altered (tampered), it is possible to recognize that the alteration (tampering) is performed. As a result, in a case of using the video file, it is possible to check the reliability (whether or not the data is tampered) of the sound data and the video data included in the video file.

### (Configuration of Processor)

The processor 11 provided in the information creation device according to the embodiment of the present invention includes various processors. Examples of the various processors include a CPU, which is a general-purpose processor that executes software (programs) to function as various processing units.

Moreover, the various processors include a programmable logic device (PLD), which is a processor of which a circuit configuration can be changed after manufacture, such as a field-programmable gate array (FPGA).

Moreover, the various processors described above also include a dedicated electric circuit, which is a processor having a circuit configuration specially designed for executing specific processing, such as an application-specific integrated circuit (ASIC).

In addition, one functional unit of the information creation device according to the embodiment of the present invention may be configured by one of the various processors. Alternatively, one functional unit of the information creation device according to the embodiment of the present invention may be configured by a combination of two or more processors of the same type or different types, for example, a combination of a plurality of FPGAs, a combination of an FPGA and a CPU, or the like.

Moreover, a plurality of functional units provided in the information creation device according to the embodiment of the present invention may be configured by one of the various processors, or may be configured by one processor in which two or more of the plurality of functional units are combined.

Moreover, as in the above-described embodiments, a form may be adopted in which one processor is configured by a combination of one or more CPUs and software, and the processor functions as the plurality of functional units.

In addition, for example, as typified by a system-on-chip (SoC) or the like, a form may be adopted in which a processor is used which realizes the functions of the entire system including the plurality of functional units in the information creation device according to the embodiment of the present invention with one integrated circuit (IC) chip. Further, a hardware configuration of the various processors may be an electric circuit (circuitry) in which circuit elements, such as semiconductor elements, are combined.

### EXPLANATION OF REFERENCES

10: information creation device
11: processor
12: memory
13: communication interface
14: input device
15: output device
16: storage
20: imaging apparatus
21: acquisition unit
22: specifying unit
23: first creation unit
24: second creation unit
25: statistical processing unit
26: display unit
27: analysis unit
28: notification unit

What is claimed is:

1. An information creation method comprising:
a first acquisition step of acquiring sound data including a plurality of sounds emitted from a plurality of sound sources; and
a creation step of creating text information obtained by converting the sound into text and related information on the conversion of the sound into text, as accessory information on video data corresponding to the sound data.

2. The information creation method according to claim 1,
wherein the related information includes reliability information on reliability of the conversion of the sound into text.

3. The information creation method according to claim 2, further comprising:
a second acquisition step of acquiring the video data including a plurality of image frames,
wherein, in the creation step, correspondence information indicating a correspondence relationship between two or more image frames among the plurality of image frames and the text information is created as the accessory information,
the text information is information on a phrase, a clause, or a sentence obtained by converting the sound into text, and
the reliability information is information on the reliability of the phrase, the clause, or the sentence for the sound.

4. The information creation method according to claim 1, further comprising:
a second acquisition step of acquiring the video data including a plurality of image frames,
wherein, in the creation step, sound source information on the sound source and presence/absence information on whether or not the sound source is present within an angle of view of a corresponding image frame are created as the accessory information.

5. The information creation method according to claim 2,
wherein, in a case in which the reliability of the text information is lower than a predetermined criterion, in the creation step, alternative text information on text different from the text information is created for the sound.

6. The information creation method according to claim 1,
wherein the related information includes error information on an utterance error of an utterer as the sound source.

7. The information creation method according to claim 2,
wherein, in the creation step, the reliability information is created based on a classification of a content of the sound.

8. The information creation method according to claim 1,
wherein, in the creation step, sound source information on an utterer as the sound source is created, and
the related information includes rate information on a rate of match between movement of a mouth of the utterer and the text information.

9. The information creation method according to claim 1,
wherein the related information includes utterance method information on an utterance method of the sound.

10. The information creation method according to claim 1,
wherein, in the creation step, first text information obtained by converting the sound into text by maintaining a language system of the sound and second text information obtained by converting the sound into text by changing the language system are created as the text information, and
the related information includes language system information on the language system of the first text information or the second text information or change information on the change of the language system of the second text information.

11. The information creation method according to claim 10,
wherein the related information includes information on reliability of the second text information.

12. The information creation method according to claim 2,
wherein, in the creation step, the text information and the reliability information are created for each of the plurality of sounds, and
the information creation method further comprises a display step of displaying statistical data obtained by executing statistical processing on the reliability information created for each of the plurality of sounds.

13. The information creation method according to claim 2, further comprising:
an analysis step of analyzing, in a case in which the reliability indicated by the reliability information is lower than a predetermined criterion, a cause of the reliability being lower than the predetermined criterion; and
a notification step of notifying of the cause.

14. The information creation method according to claim 13,
wherein, in a case in which information other than the text information in the accessory information is used as non-text information, in the analysis step, the cause is specified based on the non-text information.

15. The information creation method according to claim 1, further comprising:
a determination step of determining whether or not the sound data or the video data is altered, based on the text information and movement of a mouth of an utterer of the sound in the video data.

16. The information creation method according to claim 1,
wherein the sound is a verbal sound.

17. An information creation device comprising:
a processor,
wherein the processor acquires sound data including a plurality of sounds emitted from a plurality of sound sources, and
the processor creates text information obtained by converting the sound into text and related information on the conversion of the sound into text, as accessory information on video data corresponding to the sound data.

18. A video file comprising:
sound data including a plurality of sounds emitted from a plurality of sound sources;
video data corresponding to the sound data; and
accessory information on the video data,
wherein the accessory information includes text information obtained by converting the sound into text and related information on the conversion of the sound into text.
